(19) United States
(12) Patent Application Publication
(10) Pub. No.: US 2026/0094456 A1
(43) Pub. Date: Apr. 2, 2026

(54) DRIFT-FREE-HIGH-THROUGHPUT LOCALIZATION MICROSCOPY

(71) Applicant: UNIVERSITY OF PITTSBURGH-OF THE COMMONWEALTH SYSTEM OF HIGHER EDUCATION, PITTSBURGH, PA (US)

(72) Inventors: Hongqiang Ma, Sewickley, PA (US); Yang Liu, Sewickley, PA (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 19/113,647

(22) PCT Filed: Oct. 30, 2023
(86) PCT No.: PCT/US2023/078142

§ 371 Date: Mar. 20, 2025

Related U.S. Application Data
(60) Provisional application No. 63/420,847, filed on Oct. 31, 2022.

(51) Int. Cl. G06V 20/69

(52) U.S. Cl. CPC G06V 20/69

(57) ABSTRACT

A marker-free drift tracking systema and method, referred to as Adaptive localization Intersection based Drift correction (AID), for fast and precise drift correction for single-molecule localization microscopy (SMLM). The system and method utilize an adaptively adjusted position intersection map between two temporally adjacent sets of localized emitter coordinates from the imaging target to achieve robust and precise drift correction at a high computation speed.

### CROSS REFERENCE TO RELATED APPLICATIONS

This application claims priority to U.S. Provisional Patent Application Ser. No. 63/420,847, filed on Oct. 31, 2022 and titled “Drift-Free High-Throughput Localization Microscopy,” the disclosure of which is incorporated herein by reference.

### FIELD OF THE INVENTION

The disclosed concept relates generally to fluorescence microscopy, and, in particular, to a fiducial marker-free system and method for estimating and compensating for sample drift during data acquisition in fluorescence microscopy.

### BACKGROUND OF THE INVENTION

Pushing the resolution limit is one of the most important pursuits of single-molecule localization microscopy (SMLM). Over the past decade, significant effort has been expended to improve its resolution through various technical innovations, including maximizing the photon budget, integrating patterned illumination, optimizing the noise model, and optimizing the PSF model.

Another important factor that limits the image resolution is drift error. Drift correction is routinely performed in SMLM, where marker-free approaches (e.g., image cross-correlation) are often used due to their simplicity. However, these marker-less drift correction methods generally do not have sufficient speed and precision to correct high-frequency drift. This has caused some researchers to adopt a marker-assisted approach for ultraprecise distance measurement and/or achieving sub-10 nm image resolution2. It is not, however, a trivial task to popularize the marker-assisted approaches. They put a higher demand on proper sample preparation to ensure the fiducial markers are located at the same imaging plane as the target of interest and remain stable throughout image acquisition. In addition, they also require the users to build additional imaging channel and workflow for marker tracking, which is also not trivial.

All in all, marker-less SMLMs are still widely used in this field. The ability to rapid and precisely correct high-frequency drift has been a long-standing problem for most commercial and custom-built SMLM systems to achieve their ultimate theoretically achievable resolution.

### SUMMARY OF THE INVENTION

In one embodiment, the disclosed concept provides a method of processing a plurality of fluorescence image frames obtained from a sample in order to estimate and compensate for sample drift. The method includes receiving a set of localized fluorescent emitter coordinates obtained from the plurality of fluorescence image frames, splitting the set of localized fluorescent emitter coordinates into a series of temporal subsets, wherein each temporal subset is associated with and based on a specified number of the image frames acquired within a certain temporal interval, wherein the temporal subsets include a reference subset, a first drift subset and a plurality of additional drift subsets. The method further includes creating a first intersected shift-map based on the reference subset and the first drift subset, and determining a first peak shift position of the first intersected shift-map. The method still further includes creating a plurality of additional intersected shift-maps using all of the additional drift subsets, wherein each additional intersected shift-map is created based on the reference subset and a respective one of the additional drift subsets, determining an additional peak shift position for each of the additional intersected shift-maps, and determining an initial drift-corrected localization dataset for the plurality of fluorescence image frames based on the first peak shift position and each of the additional peak shift positions. The method may then further include creating a final drift corrected localization dataset for the florescent image frames by repeating the aforementioned steps using the initial drift-corrected localization dataset as the reference. The final drift corrected localization dataset may then be used to compensate for sample drift during subsequent imaging processes.

In another embodiment, a microscopy system is provided that includes a control system that is structured and configured for implementing the method just described.

In yet another embodiment, a method of processing a plurality of fluorescence image frames obtained from a sample is provided that includes receiving a drift-corrected localization dataset obtained from the plurality of fluorescence image frames, splitting the drift-corrected localization dataset into a series of drift-corrected subsets including a first drift-corrected drift subset and a plurality of additional drift-corrected drift subsets, creating a first drift-corrected intersected shift-map based on a reference subset and the first drift-corrected drift subset, determining a first drift-corrected peak shift position of the first drift-corrected intersected shift-map, creating a plurality of additional drift-corrected intersected shift-maps using all of the additional drift-corrected drift subsets, wherein each additional drift-corrected intersected shift-map is created based on the reference subset and a respective one of the additional drift-corrected drift subsets, determining an additional drift-corrected peak shift position for each of the additional drift-corrected intersected shift-maps, and determining a final drift-corrected localization dataset for the plurality of fluorescence image frames based on the first drift-corrected peak shift position and each of the additional drift-corrected peak shift positions.

In still another embodiment, a microscopy system is provided that includes a control system that is structured and configured for implementing the method just described.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a fluorescence microscopy system according to an exemplary embodiment of the disclosed concept;

FIG. 2 is a schematic diagram of an exemplary control system for the fluorescence microscopy system of FIG. 1;

FIG. 3 is a flowchart illustrating a method of processing fluorescence image frames obtained from a sample according an exemplary embodiment of the disclosed concept; and

FIG. 4 is a schematic diagram illustrating the method of processing fluorescence image frames obtained from a sample according an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” shall mean that two elements are directly in contact with each other.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term “intersected shift-map” shall mean a map illustrating the number of intersected localizations at various relative shifts between the two compared localization sets.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

As described herein, the disclosed concept provides a marker-free drift tracking algorithm, referred to as Adaptive localization Intersection based Drift correction (AID), for fast and precise drift correction for single-molecule localization microscopy (SMLM). AID utilizes an adaptively adjusted position intersection map between two temporally adjacent sets of localized emitter coordinates from the imaging target to achieve robust and precise drift correction at a high computation speed. In super-resolution localization microscopy, one super-resolution image is composed of a set of localizations acquired in the imaging period. In the localization set, many localizations originate from the same emitters to ensure a sufficient Nyquist resolution. The localization set from the same imaging target acquired at different temporal points should have the intersected property (“position” in the context) in a drift-free system, based on set theory. The drift of the imaging targets reduces the probability of the intersected localizations, resulting in a lower intersection count. Therefore, the drifted positions can be precisely estimated by finding their relative position between the two temporally adjacent sets to achieve the highest intersection count.

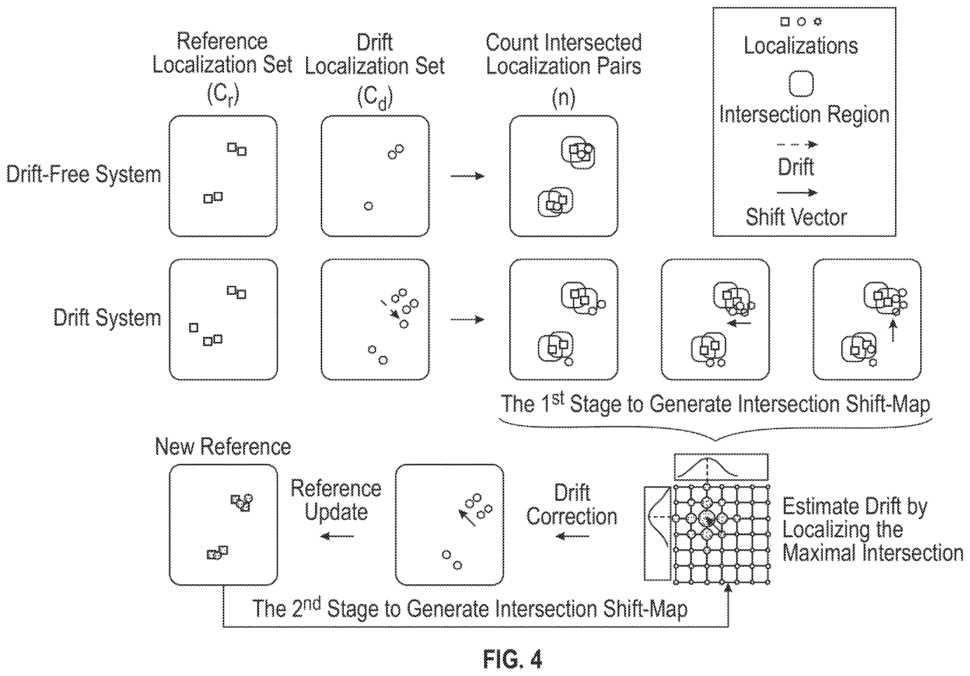

For most super-resolution localization microscopy, the spatial drift can be considered as a three-dimensional translational motion. In SMLM, a super-resolution image consists of a set of localized fluorescent emitter coordinates C={p(x₁, y₁, z₁, t₁), . . . p(x_{N}, y_{N}, z_{N}, t_{N})} acquired at different times throughout the entire imaging process, where x, y and z are each emitter's spatial coordinates, t is the emitter's temporal position, and N is the total localized points for the entire dataset. In such a dataset, many localized emitters acquired at different times originate from the same set of emitters to ensure a sufficient Nyquist resolution. In a drift-free system, those localized emitters originating from the same sets of emitters should “intersect” within a distance D determined by the localization precision (σ), which is defined as the “intersection set” (see FIG. 4). Drift reduces the number of “intersected” emitters. Therefore, the algorithm of the disclosed concept maximizes the number of intersected emitters between the two temporally separated subsets. To achieve fast and precise drift tracking, the disclosed concept, in a non-limiting exemplary embodiment, implements a two-stage coarse-to-fine adaptive processing algorithm/architecture by taking advantage of all localizations with full information to achieve robust and precise drift tracking. In the first stage, AIM performs a coarse drift correction using the temporally separated dataset. After the first stage, the entire drift-corrected dataset is then taken as a new reference for a second-stage fine drift estimation with significantly improved precision and robustness. The details of this two-stage algorithm/architecture are described below (also, See FIG. 4).

To begin the first stage, the coordinate sets of all localized emitters (C) are split into a series of temporal subsets (C₀, C₁ . . . Cₘ), where each temporal subset contains a specified number of image frames acquired within a certain temporal interval T (e.g., 20 image frames at an exposure time of 10 milliseconds within a time interval T=0.01*20=0.2 seconds). The first (initial) temporal subset coordinate (C₀) for the first interval T is referred to as the reference subset (Cᵣ), and the subsequent subsets (C₁, C₂ . . . Cₘ) for each subsequent interval T are denoted as the drift subsets.

To identify the relative drift between the reference subset (i.e., Cᵣ=C₀) and a drift subset C_{d} (e.g., C_{d}=C₁ for the first drift subset), the peak shift position on an intersected shift-map (I(d)) is calculated. When the distance of the localized coordinate pairs (d) from the reference subset and the shifted subset is less than a threshold D (e.g., 20 nm), this pair is considered as intersected. The intersected shift-map is created by calculating the number of the intersected coordinate pairs between the reference subset (Cᵣ) and a shifted subset (Cₛ), denoted as I(d)=n(Cᵣ∩Cₛ). To create a shifted subset (Cₛ), the coordinates of the drift subset C_{d} are shifted with a step size of D in a local region with a radius of R, where R should be larger than the maximum drift between two adjacent subsets (e.g., 60 nm). Then, the peak position with shift vector \vec{Sₗ}=(dᵢₓ, d_{iy}, d_{iz}) is calculated on the intersection shift-map via the computationally simple and fast Fourier harmonic analysis to determine the drift.

For the next subset (Cᵢ₊₁) (e.g., C₂), the previously determined drift \vec{Sₗ} is corrected to obtain an adaptively drift corrected subset (C_{d}=Cᵢ₊₁−\vec{Sₗ})), which is used as an updated C_{d} to find the shift vector \vec{Sₗ₊₁}, as described above. An adaptively updated drift corrected subset C_{d} based on the prior drift estimation of the previous subsets is used here, which has two key advantages. First, it transforms the long time-interval drift into short time-interval drift relative to the adjacent subset that often has a small drift distance, thus significantly reducing the searching region of intersection shift-map. Second, it can largely reject the false-positive peaks of the intersection shift-map, thus enhancing the robustness of the drift estimation. The same process is repeated for the rest of the drift subsets (e.g., C₃, . . . Cₘ).

Based on the estimated discrete drift positions at each time interval T, the time points within each interval T can be estimated by cubic spline interpolation. Then, the process subtracts the estimated drift positions at each image frame to get the drift-corrected localization dataset C_{dc}. As its calculation is based on comparison of the temporally separated subset with partial localizations, the intersection shift-map usually has a limited signal-to-noise ratio for high-precision drift tracking. This completes the first stage of the two-stage coarse-to-fine processing algorithm of the non-limiting exemplary embodiment of the disclosed concept.

To further compensate for the residual drift and achieve an improved precision, the disclosed concept, in the non-limiting exemplary embodiment, applies a second stage drift correction by taking advantage of the full dataset. The entire drift-compensated dataset C_{dc} determined above in the first stage are updated as the new reference (Cᵣ=C_{dc}) in the second stage, which can provide the highest robustness and precision to estimate the drift with full information. Then, the drift-compensated localization dataset C_{dc} is split into a series of subsets as the drift subsets (C_{dc1}, C_{dc2} . . . C_{dcm}) at the same temporal interval T as the first stage, and the steps of the first stage described above are repeated to precisely estimate the residual drift for the entire dataset. In an alternative embodiment, the second stage may be performed without performing the first stage as described above. In such an embodiment, the second stage would operate on data that is similar but not identical to the drift-compensated dataset C_{dc} as described above.

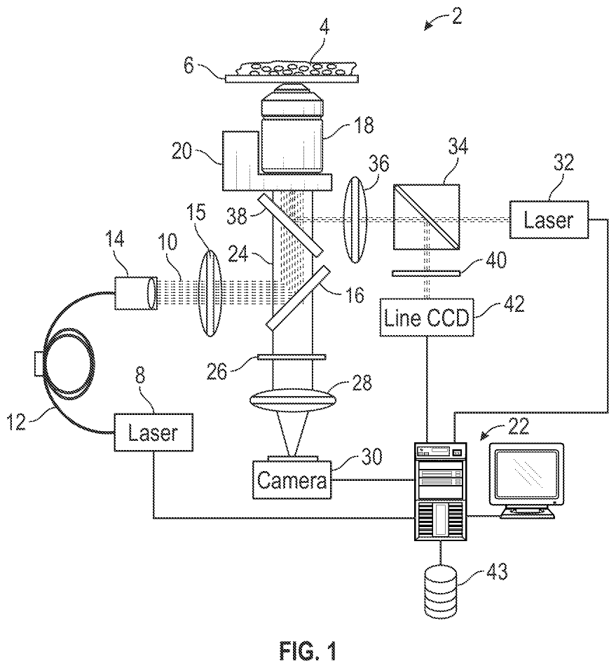

FIG. 1 is a schematic diagram of a fluorescence microscopy system 2 according to an exemplary embodiment of the disclosed concept. Fluorescent microscopy system 2 is structured and configured to obtain images (i.e., two dimensional images) from a sample 4 that, in the exemplary illustrated embodiment, is provided within a dish covered by a coverslip 6.

Fluorescence microscopy system 2 includes a laser source 8 for generating illumination light 10 that is fed through multimode fiber 12, beam collimator 14 and tube lens 15. Fluorescence microscopy system 2 further includes a dichroic mirror 16 which directs the illumination light 10 to an objective lens system 18 supported by a nanoposition stage 20. Both laser source 8 and nanoposition stage 20 are operatively coupled to a control system 22 that controls the operation thereof. Objective lens system 18 is structured to direct illumination light 10 to sample 4 in order to illuminate sample 4 and cause it to emit light 24 of certain wavelengths different than illumination light 10. Nanoposition stage 20 is structured to selectively move objective lens system 18 in the lateral (x, y,) and axial (z) directions under the control of control system 22. Fluorescence microscopy system 2 also includes an emission filter 26 which separates the emitted light 24 from the illumination light 10. A tube lens 28 is provided to direct emitted light 24 to a detector 30 which, in the illustrated exemplary embodiment, is a digital camera. Detector 30 is coupled to control system 22 to control the operation thereof and to receive data therefrom (i.e. data relating to the two dimensional images that are captured).

In addition, as seen in FIG. 1, fluorescence microscopy system 2 further includes a laser source 32, a beam splitter 34, a tube lens 36, a dichroic mirror 38, an emission filter 40 and a line CCD 42, which together act as a sub-system for real-time drift correction in the axial and/or lateral directions according to the disclosed concept. In particular, line CCD 42 records the intensity profile of the reflected laser beam from laser source 32 at the surface of the coverslip 6. Control system 22 then calculates the peak position of the laser beam, which is directly determined by the axial position of the sample 4. By adjusting the nanoposition stage 20, the axial drift can be compensated in real time. Furthermore, a RAID storage system 43 is provided for high-speed acquisition and storage of large image data, with control system 22 (described below) being equipped with a GPU device for high-speed image reconstruction.

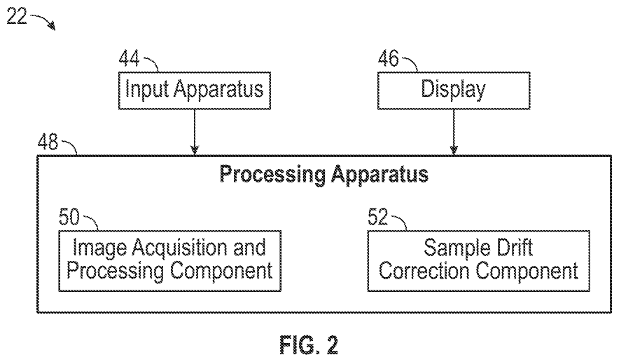

Control system 22 is structured and configured to implement the method according to the disclosed concept described herein for estimating and compensating for sample drift during data acquisition. FIG. 2 is a schematic diagram of an exemplary control system 22 according to an exemplary embodiment of the disclosed concept. As seen in FIG. 2, control system 22 is a computing device structured and configured to receive digital image data representing a number of images generated by detector 30 and process that data as described herein. Control system 22 may be, for example and without limitation, a PC, a laptop computer, or any other suitable device structured to perform the functionality described herein. Control system 22 includes an input apparatus 44 (such as a keyboard), a display 46 (such as an LCD), and a processing apparatus 48. A user is able to provide input into processing apparatus 48 using input apparatus 44, and processing apparatus 48 provides output signals to display 46 to enable display 46 to display information to the user (such as images generated from sample 4) as described in detail herein. Processing apparatus 48 comprises a processor and a memory. The processor may be, for example and without limitation, a microprocessor (μP), a microcontroller, or some other suitable processing device, that interfaces with the memory. The memory can be any one or more of a variety of types of internal and/or external storage media such as, without limitation, RAM, ROM, EPROM(s), EEPROM(s), FLASH, and the like that provide a storage register, i.e., a non-transitory machine readable medium, for data storage such as in the fashion of an internal storage area of a computer, and can be volatile memory or nonvolatile memory. The memory has stored therein a number of routines (comprising computer executable instructions) that are executable by the processor, including routines for implementing the disclosed concept as described herein. In particular, processing apparatus 48 includes an image acquisition and processing component 50 for creating fluorescence image frames from emitted light 24, including creating localized fluorescent emitter coordinates as described herein. Processing apparatus 48 also includes a sample drift correction component 52 configured for measuring and/or compensating for sample drift during data acquisition as described herein.

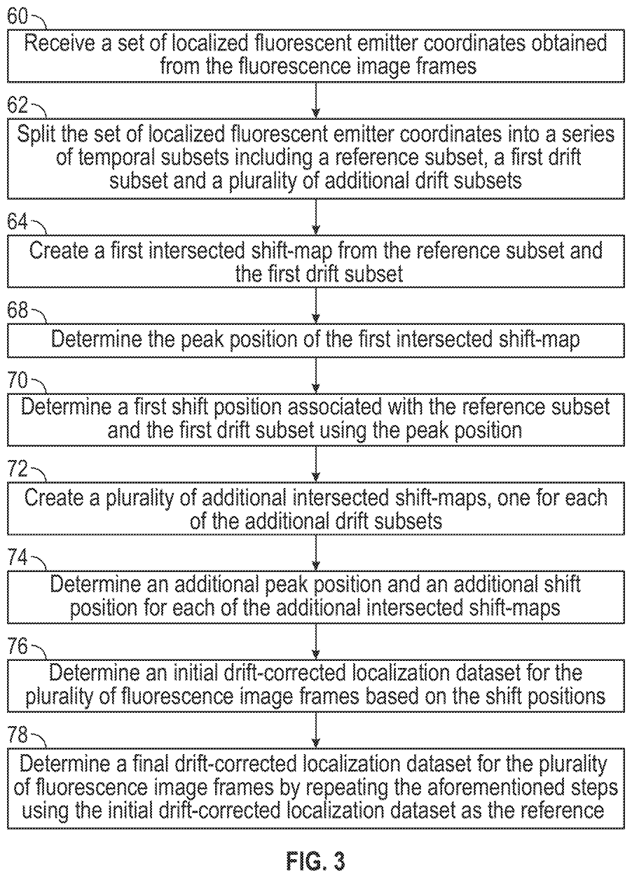

FIG. 3 is a flowchart illustrating a method of processing fluorescence image frames obtained from a sample, such as, without limitation, sample 4 shown in FIG. 1, according an exemplary embodiment of the disclosed concept. In the exemplary embodiment, the method that is shown may be implemented as part of fluorescence microscopy system 2. It will be understood, however, that this is meant to be exemplary only, and that the method described herein according to the disclosed concept may be implemented in other microscopy systems without departing from the scope of the disclosed concept.

The method begins at step 60, wherein a set of localized fluorescent emitter coordinates that are obtained from the fluorescence image frames is received. Next, at step 62, the received set of localized fluorescent emitter coordinates is split into a series of temporal subsets. The temporal subsets include a reference subset and multiple drift subsets including a first drift subset and a plurality of additional drift subsets. Each temporal subset is associated with and is based on certain of the image frames that are acquired within a certain temporal interval as described herein. Next, at step 64, a first intersected shift-map is created from the reference subset and the first drift subset. Then, at step 68, the peak position of the first intersected shift-map is determined as described herein. The method then proceeds to step 70, where a shift position, referred to as the first shift position herein, associated with the reference subset and the first drift subset is determined using the just determined peak position. Then, at step 72, a plurality of additional intersected shift maps are created using all of the additional drift subsets from step 62. Each additional intersected shift-map is, in this step, created from the reference subset and a respective one of the additional drift subsets. At step 74, the peak position and the shift position are determined for each of the additional intersected shift-maps. Then, at step 76, an initial drift corrected localization dataset is determined for the plurality of fluorescence image frames based on all of the shift positions determined thus far. Finally, at step 78, a final drift corrected localization dataset is determined for the florescent image frames by repeating the aforementioned steps using the initial drift-corrected localization dataset of step 76 as the reference. The final drift corrected localization dataset may then be used to compensate for sample drift during subsequent imaging processes.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of processing a plurality of fluorescence image frames obtained from a sample, the method comprising:
receiving a set of localized fluorescent emitter coordinates obtained from the plurality of fluorescence image frames;
splitting the set of localized fluorescent emitter coordinates into a series of temporal subsets, wherein each temporal subset is associated with and based on a specified number of the image frames acquired within a certain temporal interval, wherein the temporal subsets include a reference subset, a first drift subset and a plurality of additional drift subsets;
creating a first intersected shift-map based on the reference subset and the first drift subset;
determining a first peak shift position of the first intersected shift-map;
creating a plurality of additional intersected shift-maps using all of the additional drift subsets, wherein each additional intersected shift-map is created based on the reference subset and a respective one of the additional drift subsets;
determining an additional peak shift position for each of the additional intersected shift-maps; and
determining a drift-corrected localization dataset for the plurality of fluorescence image frames based on the first peak shift position and each of the additional peak shift positions.

2. The method according to claim 1, further comprising:
splitting the drift-corrected localization dataset into a series of drift-corrected subsets including a first drift-corrected drift subset and a plurality of additional drift-corrected drift subsets;
creating a first drift-corrected intersected shift-map based on the reference subset and the first drift-corrected drift subset;
determining a first drift-corrected peak shift position of the first drift-corrected intersected shift-map;
creating a plurality of additional drift-corrected intersected shift-maps using all of the additional drift-corrected drift subsets, wherein each additional drift-corrected intersected shift-map is created based on the reference subset and a respective one of the additional drift-corrected drift subsets;
determining an additional drift-corrected peak shift position for each of the additional drift-corrected intersected shift-maps; and
determining a final drift-corrected localization dataset for the plurality of fluorescence image frames based on the first drift-corrected peak shift position and each of the additional drift-corrected peak shift positions.

3. The method according to claim 1, wherein the first intersected shift map is created by calculating a number of the intersected coordinate pairs between the reference subset and a shifted subset created from the first drift subset by shifting coordinates of the drift subset.

4. The method according to claim 3, wherein the coordinates of the drift subset are shifted with a step size of D in a local region with a radius of R, where R is larger than a maximum drift between the reference subset and the first drift subset.

5. The method according to claim 1, wherein the first peak shift position of the first intersected shift-map is determined from the first intersection shift-map via fast Fourier harmonic analysis.

6. The method according to claim 1, the first drift subset and the additional drift subsets having a temporal order, wherein each additional intersected shift-map is created from the reference subset and a respective one of the additional drift subsets in the temporal order of the additional drift subsets.

7. The method according to claim 6, wherein a first one of additional intersected shift-maps uses the first peak shift position as its origin, and wherein each remaining ones of the additional intersected shift-maps uses the additional peak shift position determined from an immediately prior additional intersected shift-map as its origin.

8. The method according to claim 2, wherein the final drift-corrected localization dataset is determined by estimating time points within each interval separating the temporal subsets using cubic spline interpolation and using the time points to compensate for drift and determine the final drift-corrected localization dataset.

9. A computer program product including a non-transitory computer readable medium encoded with a computer program product comprising program code for implementing the method of claim 1.

10. A microscopy system for obtaining a plurality of fluorescence image frames from a sample, comprising:
at least one light source for illuminating the sample;
a positioning stage for holding the sample;
at least one detector; and
a control system coupled to the at least one light source, the positioning stage and the at least one detector, wherein the control system is structured and configured to:
receive a set of localized fluorescent emitter coordinates obtained from the plurality of fluorescence image frames;
split the set of localized fluorescent emitter coordinates into a series of temporal subsets, wherein each temporal subset is associated with and based on a specified number of the image frames acquired within a certain temporal interval, wherein the temporal subsets include a reference subset, a first drift subset and a plurality of additional drift subsets;
create a first intersected shift-map based on the reference subset and the first drift subset;
determine a first peak shift position of the first intersected shift-map;
create a plurality of additional intersected shift-maps using all of the additional drift subsets, wherein each additional intersected shift-map is created based on the reference subset and a respective one of the additional drift subsets;
determine an additional peak shift position for each of the additional intersected shift-maps; and
determine a drift-corrected localization dataset for the plurality of fluorescence image frames based on the first peak shift position and each of the additional peak shift positions.

11. The microscopy system according to claim 10, wherein the first intersected shift map is created by calculating a number of the intersected coordinate pairs between the reference subset and a shifted subset created from the first drift subset by shifting coordinates of the drift subset.

12. The microscopy system according to claim 11, wherein the coordinates of the drift subset are shifted with a step size of D in a local region with a radius of R, where R is larger than a maximum drift between the reference subset and the first drift subset.

13. The microscopy system according to claim 10, wherein the first peak shift position of the first intersected shift-map is determined from the first intersection shift-map via fast Fourier harmonic analysis.

14. The microscopy system according to claim 10, wherein the control system is further structured and configured to:
split the drift-corrected localization dataset into a series of drift-corrected subsets including a first drift-corrected drift subset and a plurality of additional drift-corrected drift subsets;
create a first drift-corrected intersected shift-map based on the reference subset and the first drift-corrected drift subset;
determine a first drift-corrected peak shift position of the first drift-corrected intersected shift-map;
create a plurality of additional drift-corrected intersected shift-maps using all of the additional drift-corrected drift subsets, wherein each additional drift-corrected intersected shift-map is created based on the reference subset and a respective one of the additional drift-corrected drift subsets;
determine an additional drift-corrected peak shift position for each of the additional drift-corrected intersected shift-maps; and
determine a final drift-corrected localization dataset for the plurality of fluorescence image frames based on the first drift-corrected peak shift position and each of the additional drift-corrected peak shift positions.

15. The microscopy system according to claim 10, the first drift subset and the additional drifted subsets having a temporal order, wherein each additional intersected shift-map is created from the reference subset and a respective one of the additional drift subsets in the temporal order of the additional drift subsets.

16. The microscopy system according to claim 15, wherein a first one of additional intersected shift-maps uses the first peak shift position as its origin, and wherein each remaining ones of the additional intersected shift-maps uses the additional peak shift position determined from an immediately prior additional intersected shift-map as its origin.

17. The microscopy system according to claim 11, wherein the final drift-corrected localization dataset is determined by estimating time points within each interval separating the temporal subsets using cubic spline interpolation and using the time points to compensate for drift and determine the final drift-corrected localization dataset.

18. The microscopy system according to claim 10, further comprising a drift correction subsystem structured and configured to, together with the control system, control the positioning stage to adjust for sample drift during image capture by the microscope system based on the drift-corrected localization dataset.

19. The microscopy system according to claim 18, wherein the drift correction subsystem is structured and configured to, together with the control system, control the positioning stage to adjust for sample drift during image capture by the microscope system based on the final drift-corrected localization dataset.

20. The microscopy system according to claim 18, wherein the drift correction subsystem includes a laser for generating light that is directed toward the positioning stage and a line CCD for receiving light reflected from the positioning stage, the laser and the line CCD being coupled to and under control of the control system.

21. The microscopy system according to claim 18, wherein the drift correction subsystem includes a laser for generating light that is directed toward the positioning stage and a line CCD for receiving light reflected from the positioning stage, the laser and the line CCD being coupled to and under control of the control system.

22. A method of processing a plurality of fluorescence image frames obtained from a sample, the method comprising:
receiving a drift-corrected localization dataset obtained from the plurality of fluorescence image frames;
splitting the drift-corrected localization dataset into a series of drift-corrected subsets including a first drift-corrected drift subset and a plurality of additional drift-corrected drift subsets;
creating a first drift-corrected intersected shift-map based on a reference subset and the first drift-corrected drift subset;
determining a first drift-corrected peak shift position of the first drift-corrected intersected shift-map;
creating a plurality of additional drift-corrected intersected shift-maps using all of the additional drift-corrected drift subsets, wherein each additional drift-corrected intersected shift-map is created based on the reference subset and a respective one of the additional drift-corrected drift subsets;
determining an additional drift-corrected peak shift position for each of the additional drift-corrected intersected shift-maps; and
determining a final drift-corrected localization dataset for the plurality of fluorescence image frames based on the first drift-corrected peak shift position and each of the additional drift-corrected peak shift positions.

23. A microscopy system for obtaining a plurality of fluorescence image frames from a sample, comprising:
at least one light source for illuminating the sample;
a positioning stage for holding the sample;
at least one detector; and
a control system coupled to the at least one light source, the positioning stage and the at least one detector, wherein the control system is structured and configured to:
receive a drift-corrected localization dataset obtained from the plurality of fluorescence image frames;
split the drift-corrected localization dataset into a series of drift-corrected subsets including a first drift-corrected drift subset and a plurality of additional drift-corrected drift subsets;
create a first drift-corrected intersected shift-map based on a reference subset and the first drift-corrected drift subset;
determine a first drift-corrected peak shift position of the first drift-corrected intersected shift-map;
create a plurality of additional drift-corrected intersected shift-maps using all of the additional drift-corrected drift subsets, wherein each additional drift-corrected intersected shift-map is created based on the reference subset and a respective one of the additional drift-corrected drift subsets;
determine an additional drift-corrected peak shift position for each of the additional drift-corrected intersected shift-maps; and
determine a final drift-corrected localization dataset for the plurality of fluorescence image frames based on the first drift-corrected peak shift position and each of the additional drift-corrected peak shift positions.
